(19) United States
(12) Patent Application Publication
(10) Pub. No.: US 2024/0330685 A1
(43) Pub. Date: Oct. 3, 2024

(54) METHOD AND APPARATUS FOR GENERATING A NOISE-RESILIENT MACHINE LEARNING MODEL

(71) Applicant: Samsung Electronics Co., Ltd., Suwon-si (KR)

(72) Inventors: Minyoung KIM, Staines (GB); Timothy HOSPEDALES, Staines (GB); Da LI, Staines (GB); Xu HU, Staines (GB)

(21) Appl. No.: 18/742,494

(22) Filed: Jun. 13, 2024

Related U.S. Application Data
(63) Continuation of application No. PCT/KR2023/001153, filed on Jan. 26, 2023.

(30) Foreign Application Priority Data
Jan. 27, 2022 (GB) 2201063.1
Aug. 16, 2022 (GB) 2211951.5

(51) Int. Cl. G06N 3/08

(52) U.S. Cl. CPC G06N 3/08

(57) ABSTRACT

The present application relates to a computer-implemented method for an improved technique for optimising the loss function during deep learning. The method includes receiving a training data set comprising a plurality of data items, initialising weights of at least one neural network layer of the ML model, and training, using an iterative process, the at least one neural network layer of the ML model by inputting, into the at least one neural network layer, the plurality of data items, processing the plurality of data items using the at least one neural network layer and the weights, optimising a loss function of the weights by simultaneously minimising a loss value and a loss sharpness using weights that lie in a neighbourhood having a similar low loss value, wherein the neighbourhood is determined by a geometry of a parameter space defined by the weights of the ML model, and updating the weights of the at least one neural network layer using the optimised loss function.

### CROSS-REFERENCE TO RELATED APPLICATION(S)

This application is a continuation application, claiming priority under § 365(c), of an International application No. PCT/KR2023/001153, filed on Jan. 26, 2023, which is based on and claims the benefit of a United Kingdom patent application number 2201063.1, filed on Jan. 27, 2022, in the United Kingdom Intellectual Property Office, and to United Kingdom patent application number 2211951.5, filed on Aug. 16, 2022, in the United Kingdom Intellectual Property Office, the disclosure each of which is incorporated by reference herein in its entirety.

### TECHNICAL FIELD

The present techniques generally relate to a method and apparatus for generating a noise-resilient machine learning, ML, model. In particular, the present application relates to a computer-implemented method for an improved technique for optimising the loss function during deep learning.

### BACKGROUND ART

Deep learning neural networks learn to map a set of inputs to a set of outputs from training data. It is desirable to minimise the error between the predicted set of outputs and the actual set of inputs in order to improve the accuracy of the neural network. The error comes from a loss function. There are a number of ways to determine the loss function and to minimise the error. However, not all loss function optimisation techniques are robust to noise in the set of inputs.

Therefore, the present applicant has recognised the need for an improved technique for training a machine learning, ML, model.

### DISCLOSURE

### Technical Solution

In a first approach of the present techniques, there is provided an apparatus for training a noise-resilient machine learning, ML, model, the apparatus comprising: at least one processor coupled to memory and arranged to: receive a training data set comprising a plurality of data items; initialise weights of at least one neural network layer of the ML model; and train, using an iterative process, the at least one neural network layer of the ML model by: inputting, into the at least one neural network layer, the plurality of data items; processing the plurality of data items using the at least one neural network layer and the weights; optimising a loss function of the weights by simultaneously minimising a loss value and a loss sharpness using weights that lie in a neighbourhood having a similar low loss value, wherein the neighbourhood is determined by a geometry of a parameter space defined by the weights of the ML model; and updating the weights of the at least one neural network layer using the optimised loss function.

The ML model may be used to perform a computer vision task. In this case, the plurality of data items of the training data set may be images and/or frames of videos. The computer vision task may be any one of: object recognition, object detection, object tracking, scene analysis, pose estimation, image or video segmentation, image or video synthesis, and image or video enhancement. The ML model may be robust to noise in the images and/or frames of videos. The noise in the images and/or frames of videos may be any one or more of: occlusion of a target object, noise due to changes in lighting, and noise due to camera shake.

The ML model may be used to perform an audio analysis task. In this case, the plurality of data items of the training data set may be audio files. The audio analysis task may be any one of: audio recognition, audio classification, speech synthesis, speech processing, speech enhancement, speech-to-text, and speech recognition. The ML model may be robust to noise in the audio files. The audio files may contain speech of a target speaker, and the noise in the audio files may be one or both of: background noise, and noise due to speaker state variation.

The ML model may comprise a pre-trained backbone network. In this case, initialising weights may comprise using weights of the pre-trained backbone network, and the training data set may be the same as data used to train the pre-trained backbone network.

The ML model may comprise a pre-trained network. In this case, initialising weights may comprise using weights of the pre-trained network, and the training data set may be different to data used to train the pre-trained network.

In a second approach of the present techniques, there is provided a computer-implemented method for training a noise-resilient machine learning, ML, model, the method comprising: receiving a training data set comprising a plurality of data items; initialising weights of at least one neural network layer of the ML model; and training, using an iterative process, the at least one neural network layer of the ML model by: inputting, into the at least one neural network layer, the plurality of data items; processing the plurality of data items using the at least one neural network layer and the weights; optimising a loss function of the weights by simultaneously minimising a loss value and a loss sharpness using weights that lie in a neighbourhood having a similar low loss value, wherein the neighbourhood is determined by a geometry of a parameter space defined by the weights of the ML model; and updating the weights of the at least one neural network layer using the optimised loss function.

The method further comprises determining the geometry of a parameter space defined by the weights of the ML model by calculating a Fisher information metric of the parameter space.

The ML model may be used to perform a computer vision task. In this case, the plurality of data items of the training data set may be images and/or frames of videos. The computer vision task may be any one of: object recognition, object detection, object tracking, scene analysis, pose estimation, image or video segmentation, image or video synthesis, and image or video enhancement. The ML model may be robust to noise in the images and/or frames of videos. The noise in the images and/or frames of videos may be any one or more of: occlusion of a target object, noise due to changes in lighting, and noise due to camera shake.

The ML model may be used to perform an audio analysis task. In this case, the plurality of data items of the training data set may be audio files. The audio analysis task may be any one of: audio recognition, audio classification, speech synthesis, speech processing, speech enhancement, speech-to-text, and speech recognition. The ML model may be robust to noise in the audio files. The audio files may contain speech of a target speaker, and the noise in the audio files may be one or both of: background noise, and noise due to speaker state variation.

The ML model may comprise a pre-trained backbone network. In this case, initialising weights may comprise using weights of the pre-trained backbone network, and the training data set may be the same as data used to train the pre-trained backbone network.

The ML model may comprise a pre-trained network. In this case, initialising weights may comprise using weights of the pre-trained network, and the training data set may be different to data used to train the pre-trained network.

In a related approach of the present techniques, there is provided a computer-readable storage medium comprising instructions which, when executed by a processor, causes the processor to carry out any of the methods described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD-or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog® or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

The method described above may be wholly or partly performed on an apparatus, i.e. an electronic device, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, the present techniques may be implemented using an AI model. A function associated with AI may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/o may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

### DESCRIPTION OF DRAWINGS

Implementations of the present techniques will now be described, by way of example only, with reference to the accompanying drawings, in which:

FIG. 1A illustrates an example loss function having two local minima;

FIG. 1B illustrates neighbourhoods around each local minima of a loss function;

FIG. 2A shows a schematic diagram of a circular 2D neighbourhood;

FIG. 2B shows a schematic diagram of an ellipsoidal 2D neighbourhood;

FIG. 3 shows a contour plot of a loss function;

FIG. 4A shows a contour plot with SAM neighbourhoods, and FIG. 4B shows a contour plot with FSAM neighbourhoods;

FIG. 5A shows a contour plot with ASAM neighbourhoods, and FIG. 5B shows a contour plot with FSAM neighbourhoods;

FIG. 6 shows the Fisher SAM algorithm of the present techniques;

FIG. 7 shows a table of results from experiments performed using the CIFAR-10 and CIFAR-100 datasets;

FIG. 8 shows a table of results from experiments performed using ImageNet;

FIG. 9 shows a table of results from experiments conducted to test transfer learning of a model trained using ImageNet;

FIG. 10 shows a table of results from experiments conducted to test accuracy of a model tested using datasets that contain label noise;

FIG. 11 is a graph showing the results of experiments performed to test adversarial parameter perturbation;

FIG. 12 is a graph showing the results of experiments performed to test hyperparameter sensitivity;

FIGS. 13A and 13B illustrates a first example use case of the present techniques;

FIG. 14 illustrates a second example use case of the present techniques;

FIG. 15 illustrates a third example use case of the present techniques;

FIG. 16 is a flowchart of example steps to train a machine learning, ML, model that is robust or resilient to noise in training data; and

FIG. 17 is a block diagram of an apparatus to train a machine learning, ML, model that is robust or resilient to noise in training data.

### MODE FOR INVENTION

Broadly speaking, the present techniques generally relate to a method and apparatus for generating a noise-resilient machine learning, ML, model. In particular, the present application relates to a computer-implemented method for an improved technique for optimising the loss function during deep learning.

As neural network models get complex and deeper, the trend is over-parametrisation, numbers of parameters exceeding the training data sizes, which potentially incurs the issue of memorising training data, thus overfitting is worrisome.

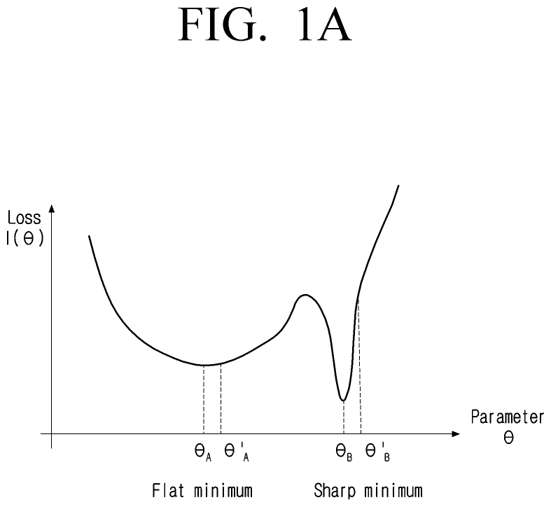

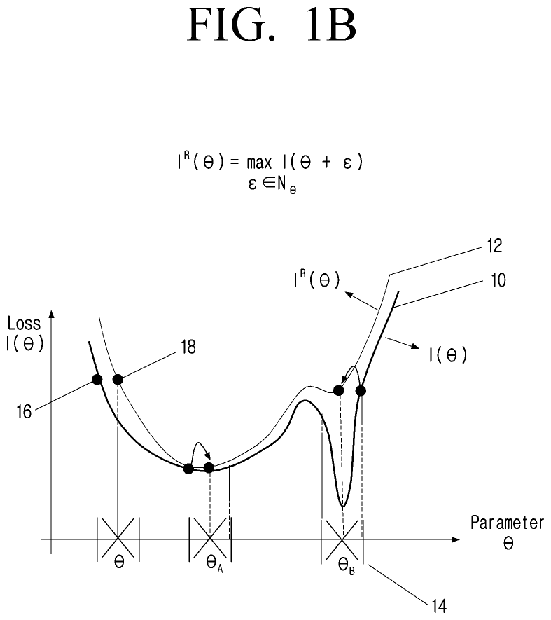

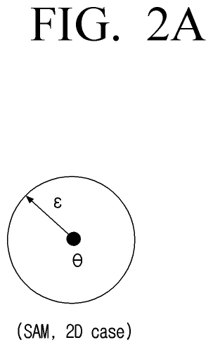

Deep learning involves the optimisation of a loss function l(θ) (defined on data) with respect to model (neural net) parameters (θ). Loss landscapes are complex and non-convex with multiple local minima. The loss function ((0) is often highly complex with many local minima. FIG. 1A illustrates an example loss function having two local minima, but it will be understood that in reality the loss function is multi-dimensional and likely to have many local minima (as well as maxima and saddle points). Optimising the loss function usually involves identifying the lowest value minima. In FIG. 1A, this may be the minimum labelled θ_{B}. However, a flat minimum is preferred to a sharp one. That is, with reference to FIG. 1A, minimum 04 may be preferred to θ_{B} even though (θ_{A})> (θ_{B}). This is because OA is more robust to data noise and model corruption.

For example, the loss l(θ) can be jittered. This may occur when the model is being trained on noisy data. The noisy data may arise due to, for example, label annotation error (particularly when data is labelled using crowdsourcing), background noise in speech data, clutters and occlusion in human pose estimation for fitness video tracking, and so on. In another example, the learned model parameters e may be corrupted. This may occur because of lossy neural net compression in mobile devices, errors from model quantization introduced to save computational resources in embedded systems/home appliances (which typically are constrained resource devices), and so on.

In FIG. 1A, the corruption of the model parameters may amount to jittering θ_{A}→θ′_{A} and θ_{B}→θ_{B}. It can be seen that the sharp minimum B suffers from a disastrous increase in the loss, while the flat A is highly robust to such noise/corruption (l(θ_{A}′A)<<l(θ_{A}′B)).

Thus, using flat minima in the loss function optimisation process results in more robust ML models, which are more resilient to data noise and/or model corruption.

Flat minima of the loss function are intuitively appealing, beneficial for finding models resilient to data noise and/or model parameter corruption/perturbation. The topic has recently gained interest. There were several noteworthy previous theoretical and empirical works, but many approaches are hardly scalable. Developing computationally efficient methods for finding flat minima is non-trivial. A seminal method in this area is known as sharpness-aware minimisation (SAM) (Foret, P., Kleiner, A., Mobahi, H., and Neyshabur, B. Sharpness-aware minimization for efficiently improving generalization. In International Conference on Learning Representations, 2021). SAM is a mini-max type algorithm that essentially modifies the loss function to report the maximum loss value within the small neighbourhood around the current iterate. Optimising with SAM thus prefers flatter minima than conventional Stochastic Gradient Descent SGD. (SGD is widely used in deep learning and used to compute the approximate gradient on a small subset (minibatch) of training data.) However, one of the main drawbacks of SAM is that it uses a Euclidean ball to define the neighbourhood, which is inaccurate since loss functions for neural networks are typically defined over probability distributions (e.g., class predictive probabilities), rendering the parameter space non Euclidean. Another recent approach called Adaptive SAM (ASAM) (Kwon, J., Kim, J., Park, H., and Choi, I. K. ASAM: Adaptive Sharpness-Aware Minimization for Scale-Invariant Learning of Deep Neural Networks. In International Conference on Machine Learning, 2021) stretches/shrinks the Euclidean ball in accordance with the scales of the parameter magnitudes. However, this approach to determining the flatness ellipsoid of interest is heuristic and might severely degrade the neighbourhood structure. Although SAM and ASAM are successful in many empirical tasks, ignorance of the underlying geometry of the model parameter space may lead to suboptimal results.

The present techniques build upon the ideas of SAM, but address the issue of a principled approach to determining the ellipsoid of interest by considering information geometry of the model parameter space when defining the neighbourhood. Specifically, SAM's Euclidean balls are replaced with ellipsoids induced by the Fisher information. The approach, dubbed Fisher SAM, defines more accurate neighbourhood structures that conform to the intrinsic metric of the underlying statistical manifold. By way of comparison, SAM may probe the worst-case loss value at either a too nearby or too far point due to using a spherical neighbourhood. In contrast Fisher SAM avoids this by probing the worst-case point within the ellipsoid derived from the Fisher information at the current point-thus providing a more principled and optimisation objective, and improving empirical generalisation performance. Thus, the present techniques provide a novel information geometry and sharpness aware loss function which addresses the abovementioned issues of the existing flat-minima optimisation approaches. Fisher SAM is as efficient as SAM, only requiring double the cost of that of vanilla SGD, using the gradient magnitude approximation for Fisher information matrix. We also justify this approximation.

FIG. 1B illustrates neighbourhoods around each local minima of a loss function. A new (robust) l^{R}(θ) is defined as the worst-case loss within a small neighbourhood around θ (denoted by N_{θ}). In FIG. 1B, cross 14 denotes N_{θ} (a neighbourhood around θ), curve 10 shows the original loss l(θ), curve 12 shows the new robust loss l^{R}(θ), dots 16 show the worst-case value in N_{θ}, and dots 18 show the new robust loss value. Since the sharp minimum (θ_{B}) has a larger increase within N_{θ}_{_{B}}, it has a higher value in the new loss. On the other hand, the flat minimum (θ_{B}) has a smaller increase within N_{θ}_{_{A}}, and so it has a relatively lower value in the new loss l^{R}(θ). With the new loss l^{R}(θ), a conventional stochastic gradient optimization process can be performed to identify the flat minima.

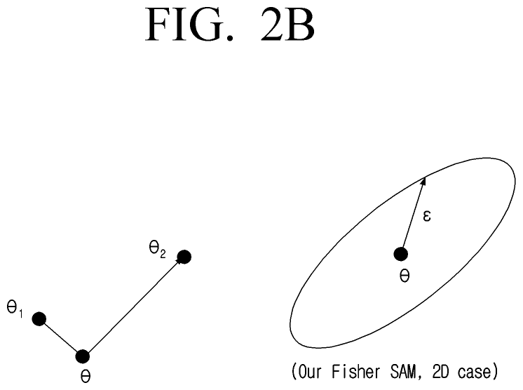

The question then becomes: how should the neighbourhood N_{θ} be defined? In the recent Foret et al paper, a Euclidean ball was considered, where N_θ={θ+∈−l| ∥∈∥≤γ}. FIG. 2A shows a schematic diagram of a circular, or Euclidian ball-shaped, 2D neighbourhood.

However, as noted above, one of the main drawbacks of SAM is that it uses the Euclidean ball to define the neighbourhood, which can be less accurate since loss functions for neural networks are typically defined over probability distributions (e.g., class predictive probabilities), rendering the parameter space no more Euclidean. Similarly, the recent Adaptive SAM approach that stretches/shrinks the Euclidean ball in accordance with the scales of the parameter magnitudes, might be dangerous, potentially destroying the neighbourhood structure even severely. Although they are successful in many empirical tasks, ignorance of underlying geometry of the model parameter space may lead to suboptimal results.

The present techniques address this issue by considering information geometry of the model parameter space when defining the neighbourhood, namely replacing SAM's Euclidean balls with ellipsoids induced by the Fisher information. The approach (Fisher SAM or FSAM), defines more accurate neighbourhood structures that conform to the intrinsic metric of the underlying statistical manifold. As a comparative highlight, SAM may probe the worst-case loss value at either a too nearby or inappropriately distant point due to the ignorance of the parameter space geometry, which is avoided by Fisher SAM. Instead, Fisher SAM probes the worst-case point within the equal distance ball derived from the Fisher information at the current point. Similarly, ASAM stretches/shrinks the Euclidean ball in accordance with the scales of the parameter magnitudes, might be dangerous, potentially destroying the neighbourhood structure even severely.

FIG. 2B shows a schematic diagram of an ellipsoidal 2D neighbourhood. As shown in FIG. 2B, from the theory of information geometry, the geometry of neural network parameters is not Euclidean, and the true distance d(θ, θ₁)=d(θ, θ₂) even though ∥|θ−θ₁∥<<∥θ−θ₂∥. Rather, the geometry of neural network parameters is a Fisher metric space (ellipsoid shown in FIG. 2B), where N_θ={θ+ε┤|∈\hat{ }τF(θ)ε≤γ\hat{ }2}. Thus, the Fisher SAM of the present techniques respects the parameter space geometry.

SAM & ASAM: Although flatness/sharpness of the loss function can be formally defined using the Hessian, dealing with (optimizing) the Hessian function is computationally prohibitive. As a remedy, sharpness-aware minimisation (SAM) introduced a novel robust loss function, where the new loss at the current iterate is defined as the maximum (worst-case) possible loss within the neighbourhood at around it. More formally, considering a γ-ball neighbourhood, the robust loss lγ is defined as:

$${l}^{γ} ( θ ) = {max}_{‖ ε ‖ \leq γ} l ( θ + ϵ ) , \qquad Equation 1$$

where θ is the model parameters (iterate), and l((θ) is the original loss function. Using the first-order Taylor (linear) approximation of l(θ+ε), (l) becomes the famous dual-norm problem, admitting a closed-form solution. In the Euclidean (L2) norm case, the solution becomes the normalized gradient,

$${ϵ}_{SAM}^{*} ( θ ) = γ \frac{∇ l ( θ )}{‖ ∇ l ( θ ) ‖} . \qquad Equation 2$$

Plugging (2) into (1) defines the SAM loss, while its gradient can be further simplified by ignoring the (higher-order) gradient terms in ∇∈*(θ) for computational tractability:

$${{l}_{SAM}^{γ} ( θ ) = l ( {θ}^{′} ) , ∇ {l}_{SAM}^{γ} ( θ ) = \frac{\partial l ( θ )}{\partial θ} \vert}_{θ = {θ}^{′}} \qquad Equation 3$$

$$where {θ}^{′} = θ + {ϵ}_{SAM}^{*} ( θ ) .$$

In terms of computational complexity, SAM incurs only twice the forward/backward cost of the standard SGD: one forward/backward for computing ∈*_{SAM}(θ) and the other for evaluating the loss and gradient at θ′=+∈*_{SAM}(θ).

A drawback of SAM, related to the model parameterisation, was raised by Kwon et al, in which SAM's fixed-radius γ-ball can be sensitive to the parameter re-scaling, weakening the connection between sharpness and generalisation performance. To address the issue, they proposed what is called Adaptive SAM (ASAM for short), which essentially re-defines the neighbourhood γ-ball with the magnitude-scaled parameters. That is,

$${l}_{ASAM}^{γ} ( θ ) = {max}_{‖ \frac{{m}_{ε}}{\vert θ \vert} ‖ \leq γ} l ( θ + ϵ ) , \qquad Equation 4$$

$$where \vert θ \vert$$

is the elementwise operation (i.e.,

$$\frac{{ϵ}_{i}}{\vert {θ}_{i} \vert}$$

for each axis i). It leads to the following maximum (worst-case) probe direction within the neighbourhood,

$${ϵ}_{SAM}^{*} ( θ ) = γ \frac{{θ}^{2} ∇ l ( θ )}{‖ θ ∇ l ( θ ) ‖} ( elementwise ops . ) . \qquad Equation 5$$

The loss and gradient of ASAM are defined similarly as (3) with θ′=θ+ε*_{ASAM}(θ).

Fisher SAM: ASAM's yγ-neighbourhood structure is a function of θ, thus not fixed but adaptive to parameter scales in a quite intuitive way (e.g., more perturbation allowed for larger θᵢ, and vice versa). However, ASAM's parameter magnitude-scaled neighbourhood choice is rather ad hoc, not fully reflecting the underlying geometry of the parameter manifold.

Note that the loss functions for neural networks are typically dependent on the model parameters θ only through the predictive distributions p (y|x, θ) where y is the target variable (e.g., the negative log-likelihood or cross-entropy loss, l(θ)= [symbol] _{x,y}[−logp(y|x, θ)]). Hence the geometry of the parameter space manifold is not Euclidean but a statistical manifold induced by the Fisher information metric of the distribution p(y|x, θ).

The intuition behind the Fisher information and statistical manifold can be informally stated as follows. When we measure the distance between two neural networks with parameters θ and θ′, we should compare the underlying distributions p(y|x, θ) and p(y|x, θ′). The Euclidean distance of the parameters ∥θ−θ′∥ does not capture this distributional divergence because two distributions may be similar even though θ and θ′ are largely different (in L2 sense), and vice versa. For instance, even though p(x|θ)= [symbol] (μ, 1+0.001σ) and p(x|θ′)= [symbol] (μ′, 1+0.001σ′) with θ=(μ=1, σ=10) and θ′=(μ′=1, σ′=20) have large L2 distance, the underlying distributions are nearly the same. That is, the Euclidean distance is not a good metric for the parameters of a distribution family. We need to use statistical divergence instead, such as the Kullback-Leibler (KL) divergence, from which the Fisher information metric can be derived.

Based on this idea, the present techniques propose a new SAM algorithm that fully reflects the underlying geometry of the statistical manifold of the parameters. In (1) the Euclidean γ-ball is replaced by the KL divergence:

$${l}_{FSAM}^{γ} ( θ ) = {max}_{d ( θ + ϵ , θ ) \leq {γ}^{2}} l ( θ + ϵ ) where \qquad Equation 6$$

$$d ( {θ}^{′} , θ ) = 𝔼\_x [ KL ( p ( y \vert x , {θ}^{′} ) \vert \vert p ( y \vert x , θ ) ) ] ,$$

which we dub Fisher SAM (FSAM for short). For small ε, it can be shown that d(θ+ε, θ)≈∈^{τ}F(θ)ε, where F(74 ) is the Fisher information matrix,

$$F ( θ ) = {𝔼}_{x} {𝔼}_{θ} [ ∇ log p ( y \vert x , θ ) ∇ log {p ( y \vert x , θ )}^{T} ] \qquad Equation 7$$

That is, the Fisher SAM loss function can be written as:

$${l}_{FSAM}^{γ} ( θ ) = {max}_{{ϵ}^{T} F ( θ ) ϵ \leq {γ}^{2}} l ( θ + ϵ ) \qquad Equation 8$$

Equation 8 is solved using the first-order approximated objective l(74 +ε)≈l (74 )+Ε(θ)^{T}ε, leading to a quadratic constrained linear programming problem. The Lagrangian is

$$ℒ ( ϵ , λ ) = l ( θ ) + ∇ {l ( θ )}^{⊤} ϵ - λ ( {ϵ}^{⊤} F ( θ ) ϵ - {γ}^{2} ) , \qquad Equation 9$$

and solving

$$\frac{\partial ℒ}{\partial ϵ} = 0$$

yields ε*∝F(θ)⁻¹∇l(θ). Plugging this into the ellipsoidal constraint results in:

$${ϵ}_{FSAM}^{*} ( θ ) = γ \frac{{F ( θ )}^{- 1} ∇ l ( θ )}{\sqrt{∇ l ( θ ) {F ( θ )}^{- 1} ∇ l ( θ )}} . \qquad Equation 10$$

The loss and gradient of Fisher SAM are defined similarly as (3) with θ′=θε*_{FSAM}(θ).

Approximating Fisher. Dealing with a large dense matrix F(θ) and its inverse) is prohibitively expensive. Following the conventional practice, we consider the empirical diagonalized minibatch approximation,

$$F ( θ ) \approx \frac{1}{\vert B \vert} {\sum }_{i ∈ B} Diag {( ∇ log p ( {y}_{i} \vert {x}_{i} , θ ) )}^{2} , \qquad Equation 11$$

for a minibatch B={(xᵢ, yᵢ)}. Diag (v) is a diagonal matrix with vector v embedded in the diagonal entries. However, it is still computationally cumbersome to handle instance-wise gradients in (11) using the off-the-shelf auto-differentiation numerical libraries such as PyTorch, Tensorflow or JAX that are especially tailored for the batch sum of gradients for the best efficiency. The sum of squared gradients in (11) has a similar form as the Generalized Gauss-Newton (GGN) approximation for a Hessian. Motivated from the gradient magnitude approximation of Hessian/GGN, the sum of gradient squares is replaced with the square of the batch gradient sum,

$$\hat{F} ( θ ) = {Diag ( \frac{1}{\vert B \vert} {\sum }_{i ∈ B} ∇ log p ( {y}_{i} \vert {x}_{i} , θ ) )}^{2} . \qquad Equation 12$$

Note that (12) only requires the gradient of the batch sum of the logits (prediction scores), a very common form efficiently done by the off-the-shelf auto-differentiation libraries. If we adopt the negative log-loss (cross-entropy), it further reduces to \hat{F}(θ)=Diag(∇l_{B}(θ))² where l_{B}(θ) is the minibatch estimate of l(θ). For the inverse of the Fisher information in (10), a small positive regulariser is added to the diagonal elements before taking the reciprocal.

Although this gradient magnitude approximation can introduce unwanted bias to the original F(θ) (the amount of bias being dependent on the degree of cross correlation between ∇logp(yᵢ|xᵢ,θ) terms), it is a widely adopted technique for learning rate scheduling also known as average squared gradients in modern optimisers such as RMSprop, Adam, and AdaGrad. Furthermore, the following theorem from Khan et al (Khan, M. E., Nielsen, D., Tangkaratt, V., Lin, W., Gal, Y., and Srivastava, A. Fast and Scalable Bayesian Deep Learning by Weight-Perturbation in Adam. In International Conference on Machine Learning, 2018.) justifies the gradient magnitude approximation by relating the squared sum of vectors and the sum of squared vectors.

Theorem 3.1 (Rephrased from Theorem 1 of Khan et al) Let {v₁, . . . , v_{N}} be the population vectors, and B⊂{1 . . . N} be a uniformly sampled (w/replacement) minibatch. Denoting the minibatch and population averages by

$$\overline{ν ( B )} = \frac{1}{\vert B \vert} {\sum }_{i ∈ B} {ν}_{i} and \overline{ν} = \frac{1}{N} {\sum }_{i = 1}^{N}$$

vᵢ, respectively, the following holds for some constant α,

$$\frac{1}{N} {\sum }_{i = 1}^{N} {ν}_{i} {ν}_{i}^{⊤} = {α𝔼}_{B} [ {\overline{ν ( B ) \overline{ν ( B )}}}^{⊤} ] + ( 1 - α ) {\overline{vv}}^{⊤} . \qquad Equation 13$$

Although it is proved in Khan et al, a full proof is provided here for self-containment.

Proof. Denote by [symbol] ᵢ (vᵢ) and [symbol] _{B}(⋅) the population variance and the variance over B, respectively. Let A be the LHS of (13). Then [symbol] (vᵢ)=A−v̅v̅^{τ}. Also

$${𝕍}_{B} ( \overline{v ( B )} ) = {𝔼}_{B} [ {\overline{ν ( B ) \overline{ν ( B )}}}^{⊤} ] - {\overline{vv}}^{⊤} since {𝔼}_{B} [ \overline{ν ( B )} ] = \overline{ν} .$$

From Theorem 2.2 of Cochran (Cochran, W. G. Sampling Techniques. Wiley, Palo Alto, CA, 1977),

$${𝕍}_{B} ( \overline{ν ( B )} ) = \frac{N - M}{M ( N - 1 )} {𝕍}_{i} ( {v}_{i} )$$

where M=|B|. By arranging the terms, we have

$$A = {α𝔼}_{B} [ {\overline{ν ( B ) \overline{ν ( B )}}}^{⊤} ] + ( 1 - α ) {\overline{vv}}^{⊤} with α = \frac{M ( N - 1 )}{N - M} .$$

The theorem essentially implies that the sum of squared gradients (LHS of (13)) gets close to the squared sum of gradients

$$( {\overline{ν ( B ) ( \overline{ν ( B )}}}^{T} or {\overline{vv}}^{T} )$$

if the batch estimate v̅(̅B̅)̅ is close enough to its population version v̅. (For instance, the two terms in the RHS of (13) can be approximately merged into a single squared sum of gradients.)

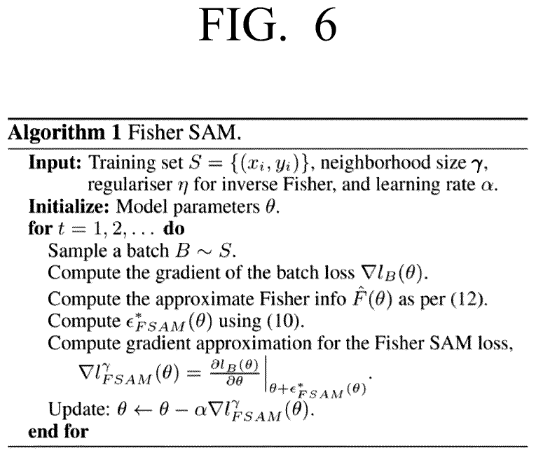

The Fisher SAM algorithm is summarized in FIG. 6. Now the main theorem for generalisation bound of Fisher SAM is stated. Specifically, the expectation of the generalization loss over the Gaussian perturbation that aligns with the Fisher information geometry is bounded.

Theorem 3.2 (Generalisation bound of Fisher SAM) Let θ⊂ [symbol] ^{k} be the model parameter space that satisfies some regularity conditions. For any θ∈θ, with probability at least 1−δ over the choice of the training set S(|S|=n), the following holds.

$${𝔼}_{ϵ} [ {l}_{D} ( θ + ϵ ) ] \leq {l}_{FSAM}^{γ} ( θ ; S ) + \sqrt{\frac{o ( k + \frac{log n}{δ} )}{n - 1}} , \qquad Equation 14$$

where l_{D}(⋅) is the generalisation loss, l_{FSAM}^{γ}(⋅; S) is the empirical Fisher SAM loss as in (8), and the expectation is over ε˜ [symbol] (0, ρ²F(θ)⁻¹) for ρ∝γ.

Remark 3.3 Compared to SAM's generalisation bound in Appendix A.1 of Foret et al, the complexity term is asymptotically identical (only some constants are different). However, the expected generalisation loss in the LHS of (14) is different: we have perturbation of θ aligned with the Fisher geometry of the model parameter space (i.e., ε˜ [symbol] (0, ρ²F(θ)⁻¹)), while in SAM they bound the generalisation loss averaged over spherical Gaussian perturbation, [symbol] _{(0,ρ}_{²}_{I)}[l_{D}(θ═∈)]. The latter might be an inaccurate measure for the average loss since the perturbation does not conform to the underlying geometry of the statistical manifold.

A proof sketch is described here.

Proof (sketch). It is an extension of the proof in Foret et al, where the PAC-Bayes bound is considered for a pre-defined set of prior distributions, from which the one closest to the posterior distribution is chosen to tighten the PAC-Bayes bound. Although in SAM, as they consider spherical Gaussian priors (corresponding to Euclidean balls), all centered at the same point, as a pre-defined set, in our case the priors are non-spherical Gaussians whose covariances are dependent on the center locations. Thus we consider a collection of Gaussians with Fisher-induced covariances as a partition of the parameter space θ. We derive the minimal KL divergence within this collection from the posterior, and with some regularity conditions the KL divergence can be tightened considerably. The proof completes by further upper-bounding the Fisher-covariance Gaussian posterior expectation by the worst-case loss within the Fisher-ellipsoidal ball.

### 2D Experiments

We devise a synthetic setup with 2D parameter space to illustrate the merits of the proposed FSAM against previous SAM and ASAM.

The model we consider is a univariate Gaussian, p(x; θ)= [symbol] (x; μ, σ²) where θ=(μ, σ)∈ [symbol] × [symbol] ₊⊂ [symbol] ². For the loss function, we aim to build a one with two local minima, one with sharp curvature, the other flat. We further confine the loss to be a function of the model likelihood p(x; θ) so that the the parameter space becomes a manifold with the Fisher information metric. To this end, we define the loss function as a negative log-mixture of two KL-driven energy models. More specifically,

$$l ( θ ) = - log ( {α}_{1} {e}^{- \frac{{E}_{1} ( θ )}{{β}_{1}^{2}}} + {α}_{2} {e}^{- \frac{{E}_{2} ( θ )}{{β}_{2}^{2}}} ) , \qquad Equation 15$$

$$where {E}_{-} i ( θ ) = K L ( p ( x ; θ ) ‖ N ( x ; {m}_{-} i , {s}_{-} i \hat{} 2 ) ) , i = 1 , 2 .$$

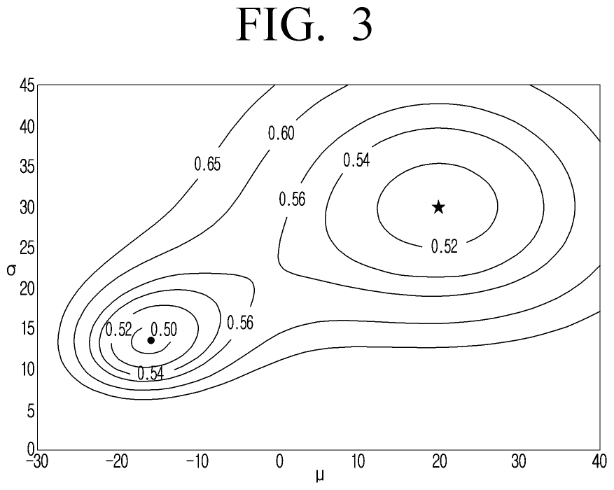

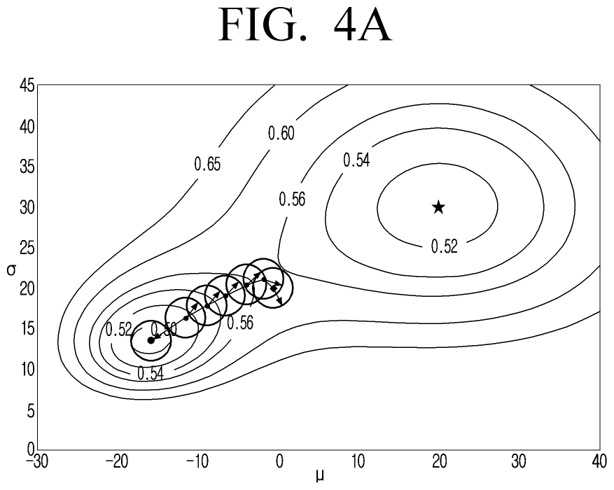

We set constants as: (m₁, S₁, α₁, β₁)=(20,30,0.7,1.8) and (m₂, S₂, α₂, β₂)=−20,10,0.3,1.2). Since Bᵢ determines the component scale, we can guess that the flat minimum is at around (m₁, S₁) (larger β₁), and the sharp one at around (m₂, S₂) (smaller β₂). The contour map of the loss function l(θ) is depicted in FIG. 3. In FIG. 3, two minima, found numerically, are shown. The two minima, and each minimum's loss value (l) and Hessian trace (H) are: θ^{flat}=(19.85,29.95) (l=0.51, H=0.001), and θ^{sharp}=(−15.94,13.46) (l=0.49, H=0.006), which are respectively shown as the blue star and the red circle in FIG. 3. We prefer the flat minimum (marked as star/blue) to the sharp one (dot/magenta) even though o sharp attains slightly lower loss.

Comparing the neighbourhood structures at the current iterate (μ, σ), SAM has a circle, {(ε_1, ε_2)|ε_1\hat{ }2+ε_2\hat{ }2≤γ\hat{ }2}, whereas FSAM has an ellipse, {(ε_1,ε_2)|ε_1\hat{ }2/2/σ\hat{ }2+ε_2\hat{ }2/(σ\hat{ }2/2)≤γ\hat{ }2} since the Fisher information for Gaussian is

$$F ( μ , σ ) = Diag ( \frac{\frac{1}{{σ}^{2 , 2}}}{{σ}^{2}} ) .$$

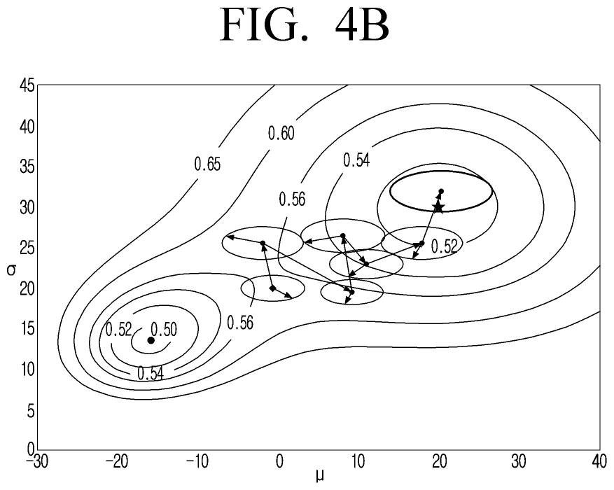

Note that the latter is the intrinsic metric for the underlying parameter manifold. Thus when σ is large (away from 0), it is a valid strategy to explore more aggressively to probe the worst-case loss in both axes (as FSAM does). On the other hand, SAM considers relatively too little perturbations, which hinders finding a sensible robust loss function. This scenario is illustrated in FIGS. 4A and 4B.

FIG. 4A shows a contour plot with SAM neighbourhoods, and FIG. 4B shows a contour plot with FSAM neighbourhoods. In each plot, the x-axis is μ and the y-axis is o. FIG. 4A (SAM) shows that SAM failed due to the invalid neighbourhood structure of Euclidean ball. FIG. 4B (FSAM) shows that FSAM finds the flat minimum due to the valid neighbourhood structure from Fisher information metric. Initial iterate shown as diamond/green; the neighbourhood ball is depicted as yellow circle/ellipse; the worst-case probe within the neighbourhood is indicated by cyan arrow, update direction is shown as red arrow. The sizes of circles/ellipses are adjusted for better visualisation.

The initial iterate (diamond/green) has a large o value, and FSAM makes aggressive exploration in both axes, helping us moving toward the flat minimum. On the other hand, SAM makes too narrow exploration, merely converging to the relatively nearby sharp minimum.

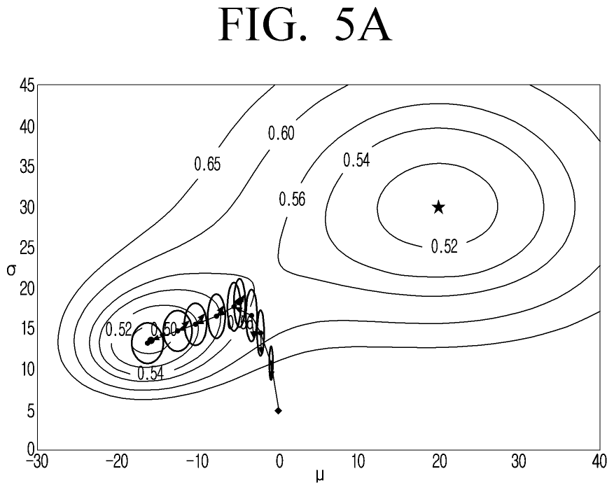

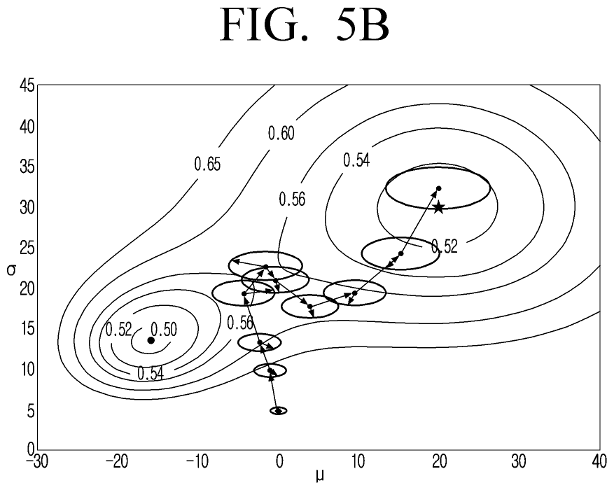

For ASAM, the neighbourhood at current iterate (μ,σ) is the magnitude-scaled ellipse, {(ε_1,ε_2)|ε_1\hat{ }2/μ\hat{ }2+ε_2\hat{ }2/σ\hat{ }≤γ2}. Thus when μ is close to 0, for instance, ε₁ is not allowed to perturb much, hindering effective exploration of the parameter space toward robustness, as illustrated in FIGS. 5A and 5B. FIG. 5A shows a contour plot with ASAM neighbourhoods, and FIG. 5B shows a contour plot with FSAM neighbourhoods. The x-axis is μ and the y-axis is o. FIG. 5B shows that ASAM failed due to the invalid neighbourhood structure: especially when the magnitude of a particular parameter value is small (close to 0), it overly penalizes perturbation along the axis. Here the parameter u has small magnitudes initially, which forms incorrect neighbourhood ball overly shrunk along the X-axis, preventing it from finding a worst-case probe through X-axis perturbation. FIG. 5B shows that FSAM finds the flat minimum due to the valid neighbourhood structure from Fisher information metric. Initial iterate shown as diamond/green; the neighbourhood ball is depicted as yellow circle/ellipse; the worst-case probe within the neighbourhood is indicated by cyan arrow, update direction is shown as red arrow.

Experiments. The present applicant empirically demonstrates generalisation performance and noise robustness of the proposed Fisher SAM method. As competing approaches, the vanilla (non-robust) optimization (SGD) is considered as a baseline, as well as SAM, that uses Euclidean-ball neighbourhood and ASAM, that employs parameter-scaled neighbourhood that employs parameter-scaled neighbourhood. The present approach, forming Fisher-driven neighbourhood, is denoted by FSAM.

For the implementation of Fisher SAM in the experiments, instead of simply adding a regulariser to each diagonal entry fᵢ of the Fisher information matrix \hat{F}(θ), we take

$$\frac{1}{1 + η {f}_{i}}$$

as the diagonal entry of the inverse Fisher. Hence n serves as anti-regulariser (e.g., small η diminishes or regularizes the Fisher impact). We find this implementation performs better than simply adding a regulariser. In most of our experiments, we set η=1.0. Certain multi-GPU/TPU gradient averaging heuristics called the m-sharpness trick empirically improves the generalisation performance of SAM and ASAM [Foret et˜al. (2021) Foret, Kleiner, Mobahi, and Neyshabur]. However, since the trick is theoretically less justified, we do not use the trick in our experiments for fair comparison.

Image Classification. The goal of this section is to empirically compare generalisation performance of competing loss functions: SGD, SAM, ASAM, and our FSAM. Here, SGD=vanilla (non-robust) optimization; SAM (Foret et al. 2021)=robust optim w/Euclidean-ball neighbourhood; ASAM (Kwon et al. 2021)=robust optim w/parameter-scaled neighbourhood; and FSAM=proposed Fisher SAM (Fisher info neighbourhood).

Following the experimental setup suggested in Foret et al and Kwon et al, we employ several ResNet-based backbone networks including WideResNet, VGG, DenseNet, ResNeXt, and PyramidNet on the CIFAR-10/100 datasets. Similar to Foret et al and Kwon et al, the SGD optimiser is used with momentum 0.9, weight decay 0.0005, initial learning rate 0.1, cosine learning rate scheduling, for up to 200 epochs (400 for SGD) with batch size 128. For the PyramidNet, we use batch size 256, initial learning rate 0.05 trained up to 900 epochs (1800 for SGD). We also apply Autoaugment, Cutout data augmentation, and the label smoothing with factor 0.1 is used for defining the loss function.

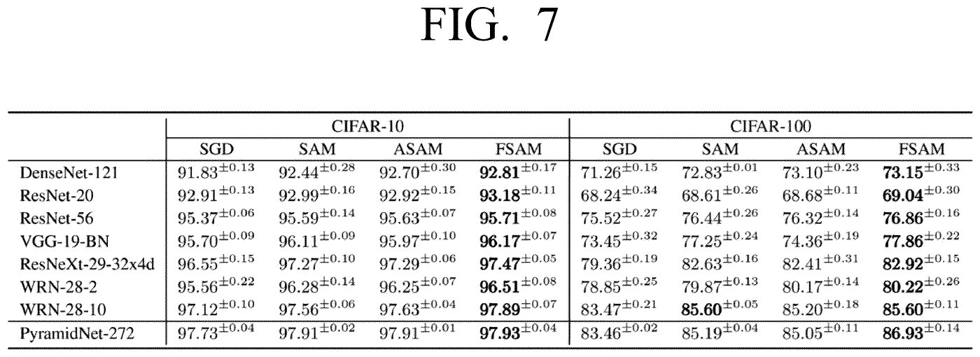

We perform the grid search to find best hyperparameters (γ, η) for FSAM, and they are (γ=0.1, η=1.0) for both CIFAR-10 and CIFAR-100 across all backbones except for PyramidNet. For the PyramidNet on CIFAR-100, we set (γ=0.5, η=0.1). For SAM and ASAM, we follow the best hyperparameters reported in their papers: (SAM) y=0.05 and (ASAM) γ=0.5, η=0.01 for CIFAR-10 and (SAM) γ=0.1 and (ASAM) γ=1.0, η=0.1 for CIFAR-100. For the PyramidNet, (SAM) γ=0.05 and (ASAM) γ=1.0. The results are summarized in FIG. 7, where Fisher SAM consistently outperforms SGD and previous SAM approaches for all backbones. This can be attributed to FSAM's correct neighbourhood estimation that respects the underlying geometry of the parameter space.

Extra (Over-) Training on ImageNet. For a large-scale experiment, we consider the ImageNet dataset (Deng, J., Dong, W., Socher, R., Li, L.-J., Li, K., and Fei-Fei, L. ImageNet: A large-scale hierarchical image database. In IEEE Conference on Computer Vision and Pattern Recognition, 2009). We use the DeiT-base (denoted by DeiT-B) vision transformer model (Touvron, H., Cord, M., Douze, M., Massa, F., Sablayrolles, A., and Jegou, H. Training data-efficient image transformers & distillation through attention. In International Conference on Machine Learning, 2021) as a powerful backbone network. Instead of training the DeiT-B model from the scratch, we use the publicly available ImageNet pre-trained parameters as a warm start (available from https://github.com/facebookresearch/deit), and perform fine-tuning with the competing loss functions. Since the same dataset is used for pre-training and fine-tuning, it can be better termed extra/over-training.

The main goal of this experimental setup is to see if robust sharpness-aware loss functions in the extra training stage can further improve the test performance. First, we measure the test performance of the pre-trained DeiT-B model, which is 81.94% (Top-1) and 95.63% (Top-5). After three epochs of extra training, the test accuracies of the competing approaches are summarized in FIG. 8. FIG. 8 shows a table of results from experiments performed using ImageNet. Although the improvements are not very drastic, the sharpness-aware loss functions appear to move the pre-trained model further toward points that yield better generalisation performance, and our FSAM attains the largest improvement among other SAM approaches.

Transfer Learning. One of the powerful features of the deep neural network models trained on extremely large datasets, is the transferability, that is, the models tend to adapt easily and quickly to novel target datasets and/or downstream tasks by finetuning. The vision transformer model ViT-base is used with 16×16 patches (denoted by ViT-B/16) pretrained on ImageNet, and fine-tune the model on several other image datasets using competing loss functions SGD, SAM, ASAM, and FSAM. Finetuning datasets are: CIFAR100, Stanford Cars, and Flowers. We run SGD, SAM (γ=0.05), ASAM (Γ=0.1, η=0.01), and FSAM (γ=0.1, η=1.0) with the SGD optimiser for 200 epochs, batch size 256, weight decay 0.05, initial learning rate 0.0005 and the cosine scheduling.

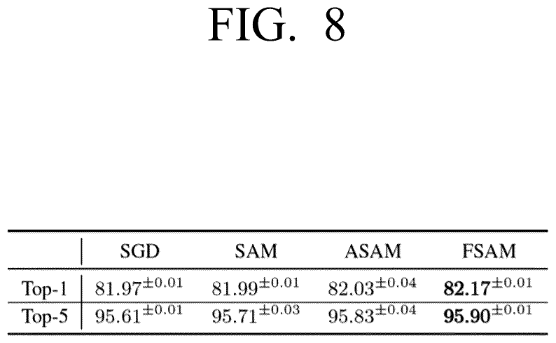

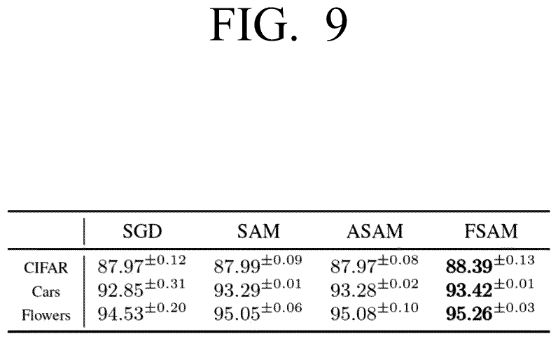

FIG. 9 shows a table of results from experiments conducted to test transfer learning of a model trained using ImageNet. The ImageNet pre-trained model is finetuned to the target datasets. It can be seen (bold text) that FSAM performs better at transfer learning than the other approaches.

Robustness to Adversarial Parameter Perturbation. Another important benefit of the proposed approach is robustness to parameter perturbation. In the literature, the generalisation performance of the corrupted models is measured by injecting artificial noise to the learned parameters, which serves as a measure of vulnerability of neural networks. Although it is popular to add Gaussian random noise to the parameters, recently the adversarial perturbation was proposed where they consider the worst-case scenario under parameter corruption, which amounts to perturbation along the gradient direction. More specifically, the perturbation process is:

$$θ \to θ + α \frac{∇ l ( θ )}{‖ ∇ l ( θ ) ‖}$$

where α>0 is the perturbation strength that can be chosen. It turns out to be a more effective perturbation measure than the random (Gaussian noise) corruption.

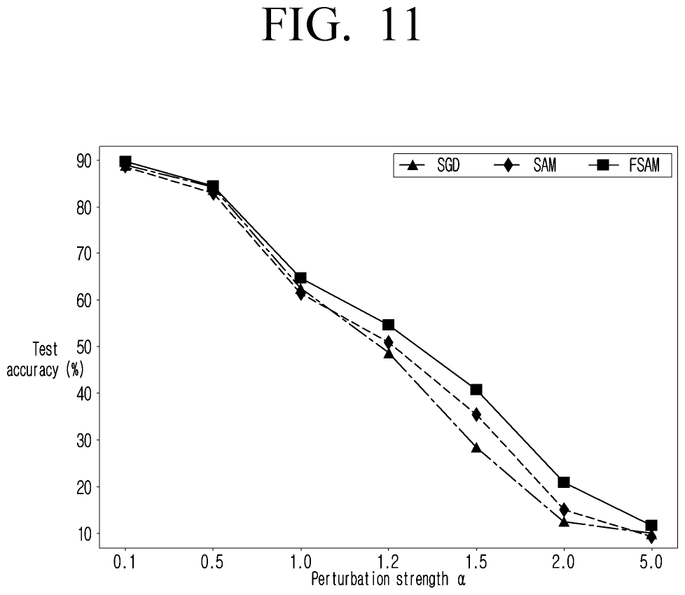

We apply this adversarial parameter perturbation process to ResNet-34 models trained by SGD, SAM (γ=0.05), and FSAM (γ=0.1, η=1.0) on CIFAR-10,where we vary the perturbation strength a from 0.1 to 5.0. The results are depicted in FIG. 11. While we see performance drop for all models as a increases, eventually reaching nonsensical models (pure random prediction accuracy 10%) after α≥5.0, the proposed Fisher SAM exhibits the least performance degradation among the competing methods, proving the highest robustness to the adversarial parameter corruption.

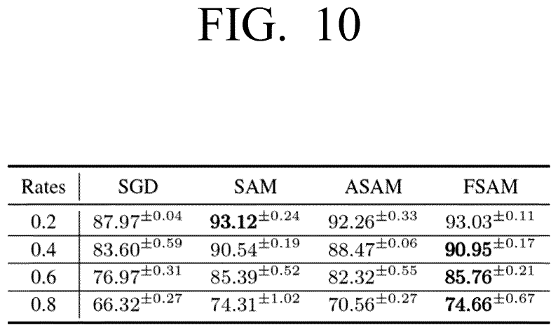

Label Noise Robustness. In the previous works, SAM and ASAM are shown to be robust to label noise in training data. Similarly as their experiments, we introduce symmetric label noise by random flipping with corruption levels 20, 40, 60, and 80% corruption levels. The results on ResNet-32 networks on the CIFAR-10 dataset are summarized in FIG. 10. FIG. 10 shows a table of results from experiments conducted to test accuracy of a model tested using datasets that contain label noise. The accuracies were tested using the CIFAR-10 dataset, with the applied noise rates being 0.2, 0.4, 0.6 and 0.8. It can be seen than for most noise rates, FSAM outperforms the other models.

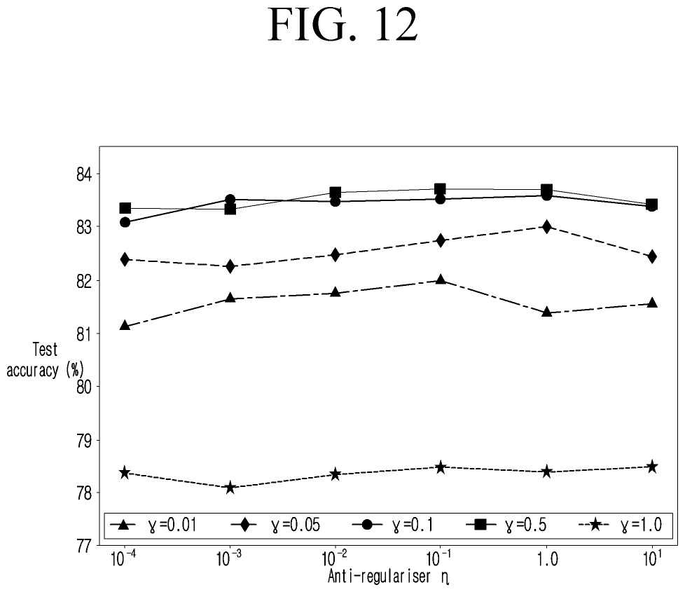

Hyperparameter Sensitivity. In our Fisher SAM, there are two hyperparameters: γ=the size of the neighbourhood and n=the anti-regularizer for the Fisher impact. We demonstrate the sensitivity of Fisher SAM to these hyperparameters. To this end, we train WRN-28-10 backbone models trained with the FSAM loss on the CIFAR-100 dataset for different hyperparameter combinations: (γ,η)∈{0.01,0.05,0.1,0.5,1.0}×{10⁻⁴, 10⁻³, 10₂, 10⁻¹, 1.0,10}. FIG. 12 is a graph showing the results of experiments performed to test hyperparameter sensitivity. The graph shows the test accuracy of the learned models. The results show that unless γ is chosen too large (e.g., γ=1.0), the learned models all perform favorably well, being less sensitive to the hyperparameter choice. But for the best performance is attained when γ lies in between 0.1 and 0.5, with some moderate values for the Fisher impact n, around 0.1 and 1.0.

As mentioned above, the loss l(θ) can be jittered. This may occur when the model is being trained on noisy data. The noisy data may arise due to, for example, label annotation error (particularly when data is labelled using crowdsourcing), background noise in speech data, clutters and occlusion in human pose estimation for fitness video tracking, and so on.

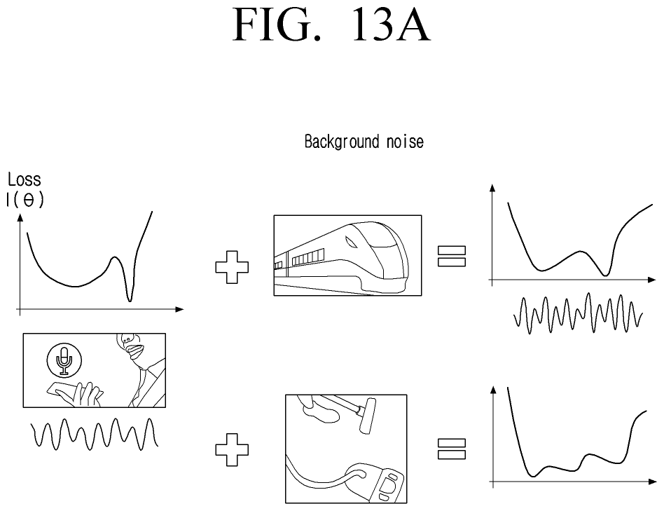

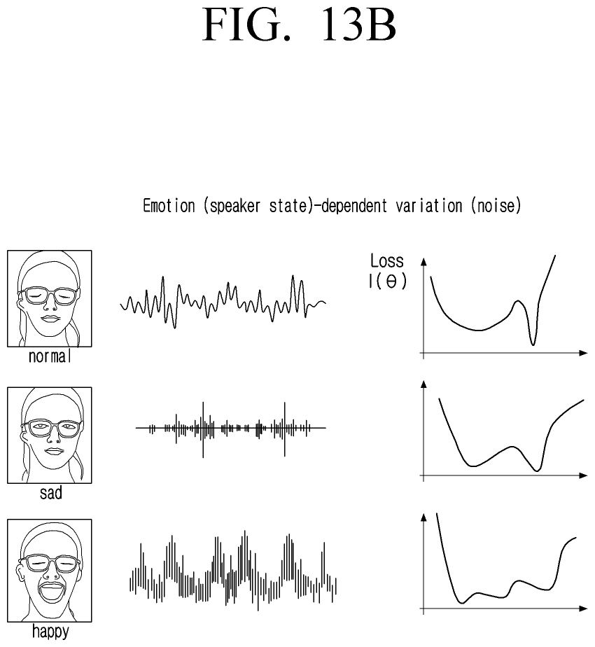

FIGS. 13A and 13B illustrates a first example use case of the present techniques. Speech data may inherently contain noise, which may be background noise (which may depend on the environment in which a speaker is located), or noise based on changes in the speaker's state or emotion. The proposed FSAM is robust to such data noise.

Thus, the ML model may be used to perform an audio analysis task. In this case, the plurality of data items of the training data set may be audio files. The audio analysis task may be any one of: audio recognition, audio classification, speech synthesis, speech processing, speech enhancement, speech-to-text, and speech recognition. The ML model may be robust to noise in the audio files. The audio files may contain speech of a target speaker, and the noise in the audio files may be one or both of: background noise, and noise due to speaker state variation.

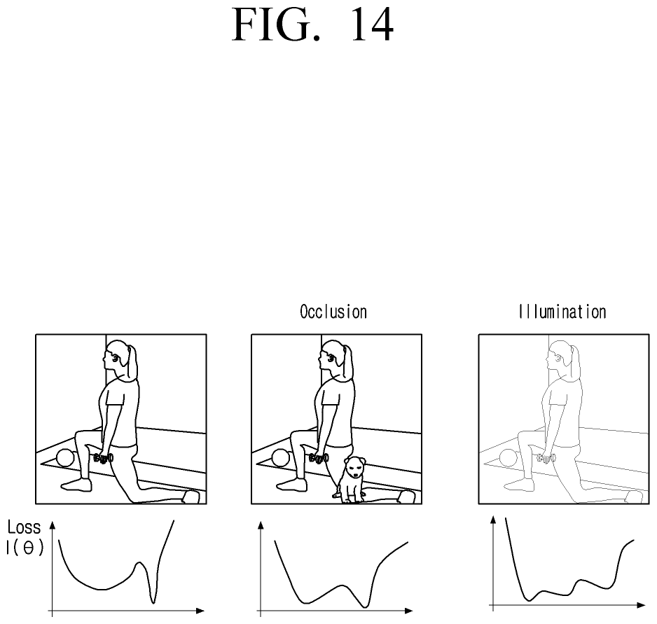

FIG. 14 illustrates a second example use case of the present techniques. In video tracking, which may be used as part of a fitness app or virtual fitness instructor app, we often encounter occlusion of the target (e.g. human) by other structures or objects, and/or noise due to changes in lighting or due to camera shake. These are all types of noise that can be viewed as loss function perturbation, and as noted above, the proposed FSAM is robust to such variations/perturbations.

Thus, the ML model may be used to perform a computer vision task. In this case, the plurality of data items of the training data set may be images and/or frames of videos. The computer vision task may be any one of: object recognition, object detection, object tracking, scene analysis, pose estimation, image or video segmentation, image or video synthesis, and image or video enhancement. The ML model may be robust to noise in the images and/or frames of videos. The noise in the images and/or frames of videos may be any one or more of: occlusion of a target object, noise due to changes in lighting, and noise due to camera shake.

As mentioned above, the learned model parameters θ may be corrupted. This may occur because of lossy neural net compression in mobile devices, errors from model quantization introduced to save computational resources in embedded systems/home appliances (which typically are constrained resource devices), and so on.

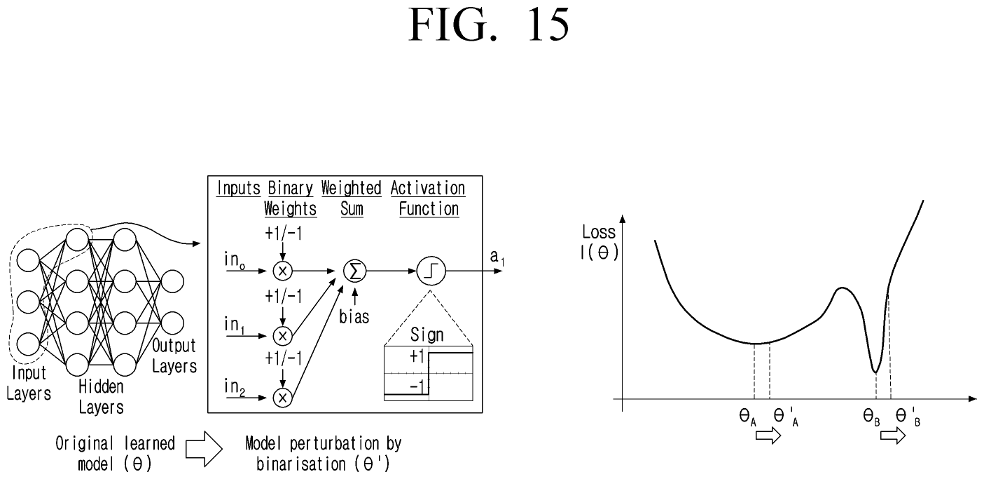

FIG. 15 illustrates a third example use case of the present techniques. In embedded systems, IoT devices or other constrained resource devices which are required to run a machine learning model, the model provided to the systems/device for use may suffer from model parameter perturbation. This may arise because of, for example, quantisation errors. Often, in order to reduce the resources (power, processor, memory, etc.) required to run a model on constrained resource devices, the model parameters may be quantised (e.g. binarized) to reduce the size of the model and/or processing required by the device at inference time. As shown above, FSAM is robust to such perturbations.

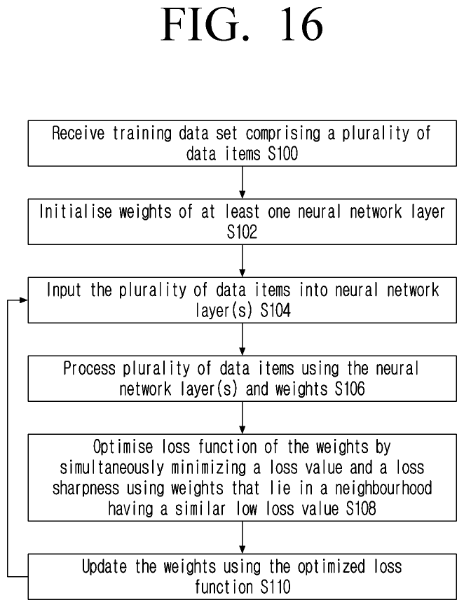

FIG. 16 is a flowchart of example steps to train a machine learning, ML, model that is robust or resilient to noise in training data. The method comprises: receiving a training data set comprising a plurality of data items (step S100) and initialising weights of at least one neural network layer of the ML model (step S102). The method comprises training, using an iterative process, the at least one neural network layer of the ML model by: inputting, into the at least one neural network layer, the plurality of data items (step S104); processing the plurality of data items using the at least one neural network layer and the weights (step S106); optimising a loss function of the weights by simultaneously minimising a loss value and a loss sharpness using weights that lie in a neighbourhood having a similar low loss value, wherein the neighbourhood is determined by a geometry of a parameter space defined by the weights of the ML model (step S108); and updating the weights of the at least one neural network layer using the optimised loss function (step S110). Steps S104 to S110 may be repeated a fixed number of times or until a required model accuracy is achieved, for example. The method may be performed by an apparatus having at least one processor coupled to memory. The apparatus may be a cloud-based server, for example.

In the case that the ML model is being trained to perform automatic speech recognition, the data items received at step S100 are audio data items comprising speech. The generated trained ML model is robust to noise in the audio data items. The noise may be background noise or speaker state variation, as shown in FIGS. 13A and 13B.

In the case that ML model is being trained to perform image analysis, such as pose estimation, the data items received at step S100 are images or video frames (which may be analysed in real-time). The generated trained ML model is robust to noise in the images. The noise may be occlusion of a target object or due to changes in lighting or camera shake, as shown in FIG. 14.

In the case that the ML model is being trained for use by embedded, low-resource devices, the generated trained ML model is robust to quantisation error, as shown in FIG. 15.

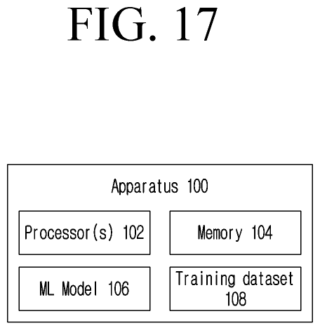

FIG. 17 is a block diagram of an apparatus 100 to train a machine learning, ML, model 106 that is robust or resilient to noise in training data. The apparatus 100 comprises at least one processor 102 coupled to memory 104. The at least one processor 102 may comprise one or more of: a microprocessor, a microcontroller, and an integrated circuit. The memory 104 may comprise volatile memory, such as random access memory (RAM), for use as temporary memory, and/or non-volatile memory such as Flash, read only memory (ROM), or electrically erasable programmable ROM (EEPROM), for storing data, programs, or instructions, for example.

The processor 102 is arranged to: receive a training data set 108 comprising a plurality of data items; initialise weights of at least one neural network layer of the ML model 106; and train, using an iterative process, the at least one neural network layer of the ML model by: inputting, into the at least one neural network layer, the plurality of data items; processing the plurality of data items using the at least one neural network layer and the weights; optimising a loss function of the weights by simultaneously minimising a loss value and a loss sharpness using weights that lie in a neighbourhood having a similar low loss value, wherein the neighbourhood is determined by a geometry of a parameter space defined by the weights of the ML model; and updating the weights of the at least one neural network layer using the optimised loss function.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

What is claimed is:

1. An apparatus for training a noise-resilient machine learning (ML) model, the apparatus comprising:
at least one processor coupled to memory and arranged to:
receive a training data set comprising a plurality of data items;
initialise weights of at least one neural network layer of the ML model; and
train, using an iterative process, the at least one neural network layer of the ML model by:
inputting, into the at least one neural network layer, the plurality of data items,
processing the plurality of data items using the at least one neural network layer and the weights,
optimising a loss function of the weights by simultaneously minimising a loss value and a loss sharpness using weights that lie in a neighbourhood having a similar low loss value, wherein the neighbourhood is determined by a geometry of a parameter space defined by the weights of the ML model, and
updating the weights of the at least one neural network layer using the optimised loss function.

2. The apparatus as claimed in claim 1 wherein the ML model is used to perform a computer vision task, and wherein the plurality of data items of the training data set are images and/or frames of videos.

3. The apparatus as claimed in claim 2, wherein the computer vision task is any one of: object recognition, object detection, object tracking, scene analysis, pose estimation, image or video segmentation, image or video synthesis, and image or video enhancement.

4. The apparatus as claimed in claim 2, wherein the ML model is robust to noise in the images and/or frames of videos.

5. The apparatus as claimed in claim 4, wherein the noise in the images and/or frames of videos is any one or more of: occlusion of a target object, noise due to changes in lighting, and noise due to camera shake.

6. The apparatus as claimed in claim 1, wherein the ML model is used to perform an audio analysis task, and wherein the plurality of data items of the training data set are audio files.

7. The apparatus as claimed in claim 6, wherein the audio analysis task is any one of: audio recognition, audio classification, speech synthesis, speech processing, speech enhancement, speech-to-text, and speech recognition.

8. The apparatus as claimed in claim 6, wherein the ML model is robust to noise in the audio files.

9. The apparatus as claimed in claim 8, wherein the audio files contain speech of a target speaker, and the noise in the audio files is one or both of: background noise, and noise due to speaker state variation.

10. The apparatus as claimed in claim 1, wherein the ML model comprises a pre-trained backbone network, wherein initialising weights comprises using weights of the pre-trained backbone network, and wherein the training data set is the same as data used to train the pre-trained backbone network.

11. The apparatus as claimed in claim 1, wherein the ML model comprises a pre-trained network, wherein initialising weights comprises using weights of the pre-trained network, and wherein the training data set is different to data used to train the pre-trained network.

12. A computer-implemented method for training a noise-resilient machine learning, ML, model, the method comprising:
receiving a training data set comprising a plurality of data items;
initialising weights of at least one neural network layer of the ML model; and
training, using an iterative process, the at least one neural network layer of the ML model by:
inputting, into the at least one neural network layer, the plurality of data items,
processing the plurality of data items using the at least one neural network layer and the weights,
optimising a loss function of the weights by simultaneously minimising a loss value and a loss sharpness using weights that lie in a neighbourhood having a similar low loss value, wherein the neighbourhood is determined by a geometry of a parameter space defined by the weights of the ML model, and
updating the weights of the at least one neural network layer using the optimised loss function.

13. The method as claimed in claim 12, further comprising determining the geometry of a parameter space defined by the weights of the ML model by calculating a Fisher information metric of the parameter space.

14. The method as claimed in claim 12, wherein the ML model is used to perform a computer vision task, and wherein the plurality of data items of the training data set are images and/or frames of videos.

15. The method as claimed in claim 14, wherein the computer vision task is any one of: object recognition, object detection, object tracking, scene analysis, pose estimation, image or video segmentation, image or video synthesis, and image or video enhancement.
